(19) United States
(12) Patent Application Publication
(10) Pub. No.: US 2026/0093762 A1
(43) Pub. Date: Apr. 2, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Junsik BANG, Suwon-si (KR); Hayoung SON, Suwon-si (KR); Ilyong PARK, Suwon-si (KR); Soosin HWANG, Suwon-si (KR)

(73) Assignee: SAMSUNG ELECTRONICS CO., LTD., Suwon-si (KR)

(21) Appl. No.: 19/353,062

(22) Filed: Oct. 8, 2025

Related U.S. Application Data
(63) Continuation of application No. PCT/KR2025/010218, filed on Jul. 11, 2025.

(30) Foreign Application Priority Data
Oct. 2, 2024 (KR) 10-2024-0133734
Jan. 2, 2025 (KR) 10-2025-0000238

(51) Int. Cl. G06F 16/9535; G06F 16/907; G10L 15/26

(52) U.S. Cl. CPC G06F 16/9535; G06F 16/907; G10L 15/26

(57) ABSTRACT

An electronic apparatus according to an embodiment of the disclosure includes a memory configured to store at least one instruction and at least one artificial intelligence model; a communication part; and at least one processor configured to, by executing the at least one instruction, cause the electronic apparatus to: receive, through the communication part, recommended content information obtained external to the electronic apparatus, based on a user input, input data, based on a user and use history information corresponding to content information viewed by the user, into the at least one artificial intelligence model, including a model trained to output recommended content information based on use history information, and provide both the recommended content information obtained external to the electronic apparatus and the recommended content information based on the user and use history information.

### CROSS-REFERENCE TO RELATED APPLICATION(S)

This application is a continuation application, claiming priority under 35 U.S.C. § 365(c), of an International application No. PCT/KR2025/010218, filed on Jul. 11, 2025, which is based on and claims the benefit of a Korean patent application number 10-2024-0133734, filed on Oct. 2, 2024, in the Korean Intellectual Property Office, and Korean patent application number 10-2025-0000238, filed on Jan. 2, 2025, in the Korean Intellectual Property Office, the disclosure of which is incorporated by reference herein in its entirety.

### TECHNICAL FIELD

The disclosure relates to an electronic apparatus and a controlling method thereof, and more particularly to an electronic apparatus that obtains recommended content information using an artificial intelligence model and a controlling method thereof.

### BACKGROUND ART

With developments in electronic technology, use of electronic products capable of recommending content of various types is increasing.

A user may request content recommendation through the electronic product, and the electronic product may provide a content suitable to the user request or a list of a plurality of contents.

In particular, recently, use of various artificial intelligence (AI) models capable of providing recommended content to the user according to personal information, and preferred genre and type of the user is increasing.

### DISCLOSURE

### Technical Solution

According to an embodiment of the disclosure, an electronic apparatus, may include: a memory configured to store at least one instruction and at least one artificial intelligence model; a communication part; and at least one processor configured to, by executing the at least one instruction, cause the electronic apparatus to: receive, through the communication part, recommended content information obtained external to the electronic apparatus, based on a user input, input data, based on the user input and use history information corresponding to content information viewed by the user, into the at least one artificial intelligence model, including a model trained to output recommended content information based on use history information, and provide both the recommended content information obtained external to the electronic apparatus and the recommended content information based on the user input and use history information.

According to an embodiment of the disclosure, a method for controlling an electronic apparatus may include: receiving recommended content information obtained external to the electronic apparatus, based on a user input ; inputting data, based on the user input and use history information corresponding to content information viewed by the user, into at least one artificial intelligence model, including a model trained to output recommended content information based on use history information, and providing both the recommended content information obtained external to the electronic apparatus and the recommended content information based on the user input and use history information.

According to an embodiment of the disclosure, a non-transitory computer-readable recording medium storing computer instructions for an electronic apparatus to perform an operation based on execution by a processor of the electronic apparatus, where the operation may include receiving recommended content information obtained external to the electronic apparatus based on a user input; inputting data, based on the user input and use history information corresponding to content information viewed by the user, into at least one artificial intelligence model, including a model trained to output recommended content information based on use history information; and providing both the recommended content information obtained external to the electronic apparatus and the recommended content information based on the user input and use history information.

### BRIEF DESCRIPTION OF DRAWINGS

FIG. 1 is a diagram illustrating an operation of an electronic apparatus according to one or more embodiments of the disclosure;

FIG. 2 is a block diagram illustrating a configuration of an electronic apparatus according to one or more embodiments of the disclosure;

FIG. 3 is a block diagram illustrating a detailed configuration of an electronic apparatus according to one or more embodiments of the disclosure;

FIG. 4 is a diagram illustrating an operation of an electronic apparatus according to one or more embodiments of the disclosure;

FIG. 5 is a diagram illustrating a first server and a second server according to one or more embodiments of the disclosure;

FIG. 6 is a diagram illustrating a third server and an operation of an electronic apparatus according to one or more embodiments or the disclosure;

FIG. 7 is a diagram illustrating an operation of an electronic apparatus according to one or more embodiments of the disclosure;

FIG. 8 is a diagram illustrating preference according to one or more embodiments of the disclosure;

FIG. 9 is a diagram illustrating a hash map according to one or more embodiments of the disclosure;

FIG. 10 is a diagram illustrating a prompt according to one or more embodiments of the disclosure; and

FIG. 11 is a flowchart illustrating a controlling method of an electronic apparatus according to one or more embodiments of the disclosure.

### MODE FOR INVENTION

The disclosure will be described in detail below with reference to the accompanying drawings

Terms used in the disclosure will be briefly described, and the disclosure will be described in detail.

The terms used in describing the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure.

Terms such as first and second may be used in describing the various elements, but the elements are not to be limited by the terms. The terms may be used only to distinguish one element from another.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The expression at least one of A or B is to be understood as indicating any one of “A” or “B” or “A and B”.

The term “module” or “part” used herein perform at least one function or operation, and may be implemented with hardware or software, or implemented with a combination of hardware and software. In addition, a plurality of “modules” or a plurality of “parts,” except for a “module” or a “part” which needs to be implemented with a specific hardware, may be integrated in at least one module and implemented as one or more processors (not shown).

Embodiments of the disclosure will be described in detail below with reference to the accompanying drawings to aid in the understanding of those of ordinary skill in the art. However, the disclosure may be implemented in various different forms and it should be noted that the disclosure is not limited to the various example embodiments described herein. Further, in the drawings, parts not relevant to the description may be omitted, and like reference numerals may be used to indicate like elements throughout the disclosure.

An embodiment of the disclosure will be described in greater detail below with reference to the accompanied drawings.

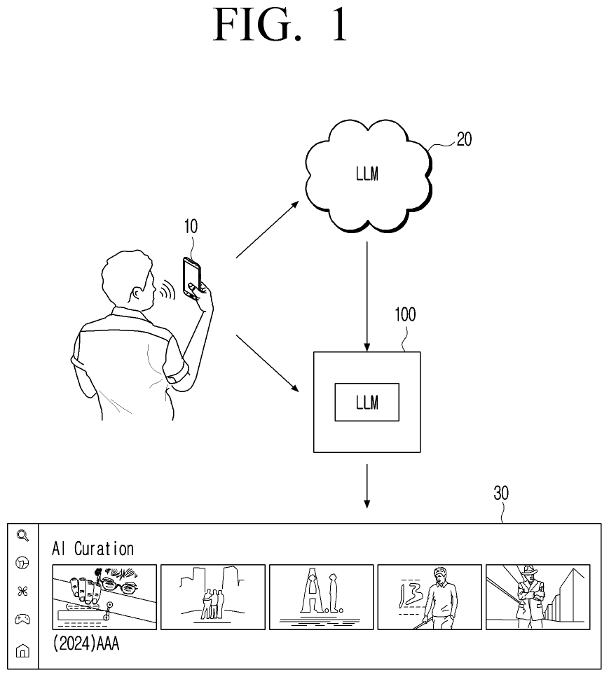

FIG. 1 is a diagram illustrating an operation of an electronic apparatus and an external electronic apparatus according to one or more embodiments of the disclosure.

Referring to FIG. 1, an electronic apparatus 100, an external electronic apparatus 10, a server 20, and recommended content information 30 are shown.

The electronic apparatus 100 and the external electronic apparatus 10 may be implemented as at least one from among a smartphone, a tablet personal computer (PC), a desktop PC, a laptop PC, a PC, a set top box, an over-the-top media service (OTT service) server, a video game console, a Blu-Ray Player, a Digital Video Disc or Digital Versatile Disc (DVD) player, a home automation control panel, a security control panel, a media box (e.g., SAMSUNG HomeSync™, APPLE TV™, or GOOGLE TV™), and a game console (e.g., Xbox™, PlayStation™). However, the embodiment is not limited thereto.

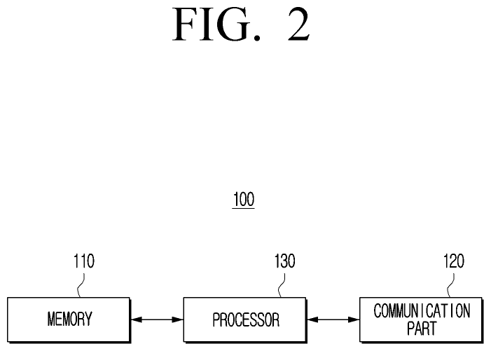

Detailed description on obtaining a plurality of images obtainable by the electronic apparatus 100 and obtaining a projection area based therefrom will be described in detail below in FIG. 2.

The external electronic apparatus 10 may be implemented, like the electronic apparatus 100, as the smartphone, the tablet PC, and the like. The external electronic apparatus 10 may be implemented in forms as shown in FIG. 1, but is not necessarily limited thereto, and may be implemented in various forms.

The server 20 may transmit and receive data with the external electronic apparatus 10, the electronic apparatus 100, or the like. The server 20 may process data received from the external electronic apparatus 10, the electronic apparatus 100, or the like and transmit to the external electronic apparatus 10, the electronic apparatus 100, or the like.

A user may utter request information through the external electronic apparatus 10. Here, the request information may be relevant to information for requesting content recommendation. For example, the user may input a speech of a content of “recommend content good to watch with a child” through the external electronic apparatus 10.

Here, the request information may be relevant to text obtained by speech to text (STT) processing the speech of the user as above. Here, STT may be a technology for converting voice to text, and may be relevant to technology with which the content spoken by the user can be converted to text.

The external electronic apparatus 10 may provide the request information described above to the electronic apparatus 100 and the server 20. The server 20 may provide, after processing the request information and obtaining a processing result, the obtained processing result to the electronic apparatus 100. Here, the processing result may be relevant to recommended content information corresponding to the request information.

Here, the recommended content information may mean information for identifying recommended content. Here, the information for identifying recommended content may be relevant to metadata of content.

Here, metadata may mean information describing characteristics, structure, meaning, and the like of the content. The metadata may make searching and managing of content easy. For example, the metadata of a moving image content (e.g., movies, dramas, music videos, etc.) may be relevant to a title, a production year, a genre, and the like.

The electronic apparatus 100 may obtain the recommended content information 30 using the processing result provided from the external electronic apparatus 10. Here, the recommended content information 30 may include metadata for the recommended content.

Meanwhile, the server 20 and the electronic apparatus 100 may process data through a large language model (LLM), respectively.

The LLM may be relevant to a natural language processing (NLP) model with a capability to understand and generate a language similar with a language of humans by learning (training) with text data of a vast amount. For example, the LLM may perform various natural language processing works such as sentence prediction, document summarization, and translation.

Here, the natural language processing model may be relevant to an artificial intelligence model trained to understand and generate a human language.

Here, the LLM may be stored in each of the server 20 and the electronic apparatus 100.

For example, the LLM stored in the server 20 may be relevant to a cloud-based LLM. Here, the cloud-based LLM may be relevant to a model which is executed on the cloud server and is accessible through a network. Here, the cloud may be relevant to a virtual IT infrastructure which flexibly provides computing resources such as a server and a storage through the Internet. Meanwhile, the LLM stored in the server 20 may be referred to as an external LLM, or the like.

Here, the external LLM may output the processing result by using the received data as input data. Here, the received data may be relevant to data provided from the external electronic apparatus 10 or the electronic apparatus 100 to the server 20. For example, the external electronic apparatus 10 may provide data corresponding to a user speech to the server.

The LLM stored in the electronic apparatus 100 may be relevant to a model directly driven from a user apparatus (e.g., smartphone, notebook). Here, the LLM stored in the electronic apparatus 100 may be referred to as an on-device LLM, an internal LLM, or the like.

The LLM stored in each of the server 20 and electronic apparatus 100 may be trained to output the recommended content information corresponding to user request information. Here, the user request information may be relevant to information input, by the user, in the external electronic apparatus 10 through speech. However, the embodiment is not limited thereto. Here, the user speech may be relevant to a speech of the user for requesting the recommended content. Here, the user request information may be referred to as a user input in the disclosure.

Here, the LLM may be trained to output the recommended content information using the user request information as the input data. Here, the user request information may be relevant to information requesting for content of a specific type and genre to be provided.

Here, the input data may include, not only the request information as described above, but also a use history and user profile information. For example, the use history may include a record of having viewed a specific content (viewing duration, viewing time period, etc.). The profile information may include gender, age, and the like of the user.

Specifically, the external LLM may receive input of use history and profile information of a plurality of users as input data. Conversely, the internal LLM may only receive input of use history and profile information of the user of the electronic apparatus 100 or the external electronic apparatus 10 as input data.

That is, the external LLM may be trained to obtain the recommended content information using information of several users as input data. Here, the recommended content information may be referred to as an externally recommended content information, or the like.

That is, the externally recommended content information may mean information on recommended contents output by the external LLM as a result. Here, the information on recommended contents may be relevant to metadata of the recommended contents.

Here, the externally recommended content information may be reflected with a preference tendency of several users. For example, the externally recommended content information may include new content, content with high rating order, real-time popular content, and the like.

Meanwhile, the internal LLM may be trained to output the recommended content information that reflects viewing characteristics of the user of the electronic apparatus 100 or the external electronic apparatus 10. Here, the recommended content information may be referred to as an internally recommended content information, or the like. Here, the internally recommended content information may be reflected with viewing characteristics of a specific user (e.g., preferred genre, production year, director, etc.)

Here, the internal LLM may receive input of the externally recommended content information obtained through the external LLM as input data. That is, the internal LLM may be trained to obtain new recommended content information (internally recommended content information reflected with viewing characteristics of the user) from the externally recommended content information. The above will be described in detail in the following description.

Meanwhile, the electronic apparatus 100 may obtain the recommended content information 30 (final recommended content information) using a result of an externally recommended content obtained through the external LLM.

Here, the final recommended content information may mean information on the recommended content provided to the user. That is, the final recommended content information may be relevant to the recommended content information after all processing steps for content recommendation is performed.

Here, the electronic apparatus 100 may obtain the final recommended content information using the external LLM as input data of the internal LLM. In addition, the electronic apparatus 100 may obtain the final recommended content information using the externally recommended content information and the internally recommended content information in parallel.

Here, the using in parallel may mean obtaining a final recommended content list by selecting the recommended content from among the externally recommended content information and the internally recommended content information. However, the embodiment is not limited thereto. The above will be described in detail in the following description.

Through the above, the electronic apparatus 100 may obtain the recommended content information that not only reflects the viewing tendencies of various users, but also a viewing tendency of a specific user (the user of the electronic apparatus 100).

An operation for obtaining the recommended content information as described above through various configurations which can be included in the electronic apparatus 100 may be described in detail below.

FIG. 2 is a block diagram illustrating a configuration of an electronic apparatus according to one or more embodiments of the disclosure.

Referring to FIG. 2, the electronic apparatus 100 may include a memory 110, a communication part 120, and a processor 130.

The memory 110 may be electrically connected with the processor 130, and store data necessary for the various embodiments of the disclosure. For example, the memory 110 may be implemented as an internal memory such as, for example, and without limitation a read-only memory (ROM) (e.g., an electrically erasable programmable read-only memory (EEPROM)), a random access memory (RAM), or the like included in the processor 130, or implemented as a memory separate from the processor 130.

The memory 110 may be implemented in a form of a memory embedded in the electronic apparatus 100 according to a data storage use, or implemented in a form of a memory attachable to or detachable from the electronic apparatus 100. For example, data for the driving of the electronic apparatus 100 may be stored in the memory embedded in the electronic apparatus 100, and data for an expansion function of the electronic apparatus 100 may be stored in the memory attachable to or detachable from the electronic apparatus 100.

When implemented as the memory embedded in the electronic apparatus 100, the memory 110 may be at least one from among a volatile memory (e.g., a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)).

Meanwhile, in the shown example, although the electronic apparatus 100 has been shown as being configured with one memory, when distinguishing and referring to the volatile memory and the non-volatile memory, the electronic apparatus 100 may be referred to as including a plurality of memories.

The memory 110 according to one or more embodiments may store at least one instruction. Here, the at least one instruction may be relevant to at least one instruction for obtaining the recommended content information by the electronic apparatus 100. Here, because the recommended content information has been described in FIG. 1, redundant descriptions thereof will be omitted.

Here, the at least one instruction may include an instruction for the electronic apparatus 100 to receive the externally recommended content information based on a user input. However, the embodiment is not limited thereto, and the at least one instruction may include various instructions for the electronic apparatus 100 to obtain the recommended content information in addition thereto. Here, the user input will be described in detail in the following description.

Meanwhile, the memory 110 may store an artificial intelligence model.

Here, the artificial intelligence model may be a computer system or a software module for implementing intelligence of a human level, and is characteristic in that a machine learns and determines on its own, and recognition rate is improved the more it is used.

The artificial intelligence model may be configured with a machine learning (deep learning) technology which uses an algorithm that classifies/learns on its own characteristics of input data and element technologies which simulate functions such as recognition and determination of a human brain utilizing the machine learning algorithm.

.Here, the artificial intelligence (AI) model may also be referred to as a neural network model, a learning model, or a deep learning model.

Examples of element technologies may include at least one from among linguistic understanding technology for recognizing language/characters of humans, visual understanding technology for recognizing objects as if from a viewpoint of a human, inference/prediction technology for logically inferring and predicting by determining information, and knowledge representation technology for processing experience information of a human as knowledge data.

Here, the artificial intelligence model may be trained to perform a natural language processing (NLP) step. Here, the natural language processing step may be implemented through the large language model (LLM). Here, because the steps of the large language model and the natural language processing have been described in FIG. 1, redundant descriptions thereof will be omitted.

Meanwhile, the artificial intelligence model may be relevant to a generative AI model. Here, a generative AI may be an AI system focused on generating new data, and may perform a function of learning a given data pattern and generating data similar therewith or completely new data. The generative AI may be distinguished from a typical artificial intelligence which has an object of analyzing data and recognizing patterns.

According to one or more embodiments, the memory 110 may store at least one artificial intelligence model.

Here, the at least one artificial intelligence model may include a model trained to output the recommended content information based on use history information. For example, the at least one artificial intelligence model may be relevant to the above-described on-device model or the internal LLM. However, the embodiment is not limited thereto.

Here, the artificial intelligence model may be trained to output the recommended content information using object use history information as input data. Here, the use history information may include viewing time, likes, number of repeated viewings, and the like for a specific content. However, the embodiment is not limited thereto.

The recommended content information may include metadata information. Because the above has been described in FIG. 1, redundant descriptions thereof will be omitted.

According to an embodiment, the at least one artificial intelligence model may include a model trained to output the recommended content information based on the use history information and the externally recommended content information.

For example, the at least one artificial intelligence model may include a model trained to obtain the recommended content based on the externally recommended content information. That is, the at least one artificial intelligence model may include a model trained to obtain the recommended content information through input data including the externally recommended content information.

Here, the at least one artificial intelligence model may output the (final) recommended content information including a portion of content from among the externally recommended content information. The above will be described in detail in the following description.

The communication part 120 may be a configuration for performing communication with external apparatuses of various types according to communication methods of various types. The communication part 120 may include a Wi-Fi module, a Bluetooth module, an infrared communication module, a wireless communication module, and the like. Here, each communication module may be implemented in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively connecting using the same, various information may be transmitted and received.

The infrared communication module may perform communication according to an infrared communication (Infrared Data Association (IrDA)) technology of transmitting data wirelessly in short range by using infrared radiation present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

In addition thereto, the communication part 120 may include at least one from among wired communication modules that perform communication using a local area network (LAN) module, an Ethernet module, a pair cable, a coaxial cable, an optical fiber cable, an Ultra Wide-Band (UWB) module, or the like. The communication part 120 as described may be referred to as a transceiver.

Meanwhile, the electronic apparatus 100 may receive a signal requesting for the recommended content information, or the like by the electronic apparatus 100 from an external apparatus (e.g., external server, etc.) through the communication part 120. In this case, the electronic apparatus 100 may transmit the obtained recommended content information to the server or the like, and the external apparatus may obtain new recommended content information using the received recommended content information. However, the embodiment is not limited thereto.

Alternatively, the electronic apparatus 100 may transmit a signal requesting for the externally recommended content information or the like to the external apparatus (e.g., external electronic apparatus or server, etc.) through the communication part 120. In this case, the electronic apparatus 100 may obtain the recommended content information based on the received externally recommended content information, or the like.

Meanwhile, the electronic apparatus 100 may receive a control signal for obtaining the recommended content information from a server apparatus, or the like. However, the embodiment is not limited thereto.

Meanwhile the electronic apparatus 100 may be connected with the external apparatus or servers and further include an interface such as a HDMI port, a DP, an RGB, a DVI, a USB, a thunderbolt, and the like for receiving video/audio signals. The HDMI, the DP, and the thunderbolt may be ports with which video and audio signals may be simultaneously transmitted.

The electronic apparatus 100 may obtain the recommended content information by performing various processing such as demuxing, decoding, and scaling for various signals received from the external apparatus and the server and the like that perform communication with the external apparatus through the communication part 120 and the various interfaces described above.

According to one or more embodiments, the electronic apparatus 100 may receive through the communication part 120, recommended content information obtained external to the electronic apparatus, based on a user input.

For example, the electronic apparatus 100 may receive the externally recommended content information based on the user input through the communication part 120. Here, the user input may be relevant to input corresponding to a request for recommended content information.

Here, the request for recommended content information may be relevant to a request of the user for the user to obtain the recommended content information. The user input may be relevant to an input for obtaining the recommended content information.

Here, the user input may be relevant to an input received in the electronic apparatus 100. However, the embodiment is not limited thereto, and may be relevant to an input received in at least one external electronic apparatus communicable with the electronic apparatus 100 through the communication part 120.

The externally recommended content information based on the user input may be relevant to content information obtained by the external electronic apparatus according to a specific content (or content of a specific type, genre, etc.) included in the user input. Specifically, the externally recommended content information may be relevant to content information obtained by the external electronic apparatus according to information for requesting a specific content included in the user input.

According to an embodiment, the user input may include a text obtained from a user voice input corresponding to a request for the recommended content information. Here, the user voice input may be relevant to a voice input according to the user speech. Here, the text may mean a text obtained through STT from the user voice input. Because the STT and the like has been described above, redundant descriptions thereof will be omitted.

The processor 130 may perform an overall control operation of the electronic apparatus 100.

The processor 130 may be implemented as a digital signal processor (DSP) that processes digital signals, a microprocessor, or a time controller (TCON). However, the embodiment is not limited thereto, and may include, for example, and without limitation, one or more from among a central processing unit (CPU), a micro controller unit (MCU), a micro processing unit (MPU), a controller, an application processor (AP), a graphics-processing unit (GPU), a communication processor (CP), or an ARM processor, or may be defined by the relevant term. In addition, the processor 130 may be implemented with a System on Chip (SoC) or a large scale integration (LSI) in which a processing algorithm is embedded, and may be implemented in a form of a field programmable gate array (FPGA). In addition, the processor 130 may perform various functions by executing computer executable instructions stored in the memory. Meanwhile, in FIG. 2, although only one processor being included in the electronic apparatus 100 has been shown, at implementation, a plurality of processors (e.g., CPU+GPU, CPU+DSP) may be included.

The electronic apparatus 100 may include at least one processor. Here, the at least one processor may obtain the recommended content information by executing the at least one instruction stored in the memory 110.

According to one or more embodiments, the processor 130 may receive the externally recommended content information based on the user input through the communication part 120. Here, because the user input, externally recommended information, and the like have been described in detail above, redundant descriptions thereof will be omitted.

According to one or more embodiments, the processor 130 may obtain the recommended content information through the at least one artificial intelligence model based on data.

For example, The processor 130 may input data, based on the user input and use history information corresponding to content information viewed by the user, into the at least one artificial intelligence model.

Here, data may be data(input data) obtained based on the user input and content information viewed by the user.

Here the at least one neural network may include a model trained to output recommended content information based on use history information.

Here, the input data may be relevant to data for inputting in the at least one artificial intelligence model. For example, the input data may be relevant to data obtained based on the user input and the use history information.

Here, the input data may be relevant to data converted or generated to data in a form for inputting the user input and the use history information in the artificial intelligence model. Here, the data in a form for inputting in the artificial intelligence model may be relevant to a prompt. The above will be described in detail in the following description.

Here, the at least one artificial intelligence model may include the model trained to output the recommended content information based on the use history information. Here, because the model trained to output the recommended content information has been described above, redundant descriptions thereof will be omitted.

The processor 130 may obtain the recommended content information including a portion from among the externally recommended content information through the artificial intelligence model. For example, the recommended content information may include metadata. Here, the metadata may be relevant to metadata of each of the at least one recommended content.

Here, the metadata included in the recommended content information may include a portion from among metadata included in the externally recommended content information. Specifically, the recommended content information may include metadata included in the externally recommended content and metadata not included in the externally recommended content.

For example, the externally recommended content information may be relevant to the obtained recommended content information in the above-described external LLM. Here, the externally recommended content information may be relevant to the recommended content information corresponding to the user input.

For example, the if the user input is relevant to an input for requesting recommendations for ‘good movies to watch with a child’, the external LLM may output a recently released content from among the content with a low viewing age range, or content with high ratings as a plurality of recommended contents A, B, and C. Here, the external LLM may output metadata of the recommended content.

If the playable contents in the electronic apparatus 100 from among the plurality of recommended contents A, B, and C is A and C, the recommended content information may include the metadata for A and C. Here, the playable contents will be described in detail in the following description.

According to an embodiment, the processor 130 may obtain the prompt based on the use history information. Here, the prompt may be relevant to a prompt associated with a request for identification information for each of the at least one content corresponding to the user input. Specifically, the prompt may be an instruction (text) for requesting the identification information for each of the at least one content.

Here, the instruction may correspond to an instruction or a directive input by the user for the artificial intelligence model (LLM, etc.) to generate a desired result.

For example, the instruction may be relevant to ‘recommend movies good to watch with a child’, ‘recommend 2003 movies good to watch with a child’, or the like. As described above, the instruction may include the type, and characteristic, and the like of the content the user wishes to request.

The at least one artificial intelligence model may output the identification information using the prompt as input data. Here, the identification information may be relevant to the metadata of the recommended content. For example, the identification information may be relevant to information for identifying the recommended content such as the title, the production year, and ID (e.g., content code, etc.) of the recommended content.

In an example, the processor 130 may obtain the prompt based on the metadata included in the use history information. Here, the prompt may include a preference list for the plurality of metadata types. For example, the prompt may be the preference list for a plurality of metadata types.

Here, the preference list may be relevant to a list sorted in an order of priority by each of the types of various metadata items (e.g., title, producer, tag, etc.) according to a user preference.

For example, the processor 130 may sort a plurality of keywords in preference order by the plurality of metadata types. Here, each of the plurality of keywords may be relevant to one or more words (text) indicating the metadata of the recommended content. For example, a preference list for the plurality of metadata types may correspond to a preference list for each of the plurality of metadata types.

The processor 130 may sort the plurality of keywords as described above according to preference from the metadata included in the use history information (e.g., viewing record). Here, the plurality of keywords may be classified into a plurality of groups according to the metadata type, and sorted by groups according to preference.

Here, the preference may mean a value indicating a degree of interest the user showed for a specific content. For example, the preference may be indicated in several values according to various criteria such as, for example, and without limitation, the viewing time, a number of clicks, the number of repeated viewings, and the like.

In addition, the preference may be indicated as one value through a specific computation process using the viewing time, the number of clicks, the number of repeated viewings, and the like. In this case, the preference may be calculated as one value for each of the recommended content. Here, the specific computation process may be relevant to a computation which uses weight value.

Specifically, the processor 130 may obtain a plurality of content preferences for the plurality of viewed contents from an activity record. Here, the activity record may be relevant to a record for the plurality of viewed contents included in the use history information.

Here, the activity record may include a plurality of values divided by a plurality of activity types (e.g., viewing time, number of clicks, likes, number of repeated viewings, etc.). For example, each of the plurality of values may be recorded as the viewing time (minutes), the number of clicks, likes (number), and the like.

The processor 130 may obtain a plurality of weighted sums as the plurality of content preferences based on a plurality of weight values corresponding to the plurality of values and the plurality of activity types, respectively. The processor 130 may add the above-described weighted sum to an initially set value of 0 as the preference.

Here, a content preference may be relevant to an indicator which indicates a preference of the user for the specific content into a value. Here, the content preference may be calculated by applying a weight value according to various activity types.

Here, the weighted sum may be relevant to a value calculated for each of the plurality of viewed contents. Here, the weighted sum may mean a value summed after adding a specific weight value to each value and multiplying. Here, the specific weight value may be determined according to each of a plurality of activity types.

Through the above, the processor 130 may calculate one value (content preference) based on the plurality of values recorded according to the plurality of activity types. Here, the processor 130 may identify a content with a relatively high preference by comparing the content preferences for the plurality of viewed contents.

Meanwhile, the processor 130 may obtain a plurality of metadata preferences divided by the plurality of metadata types based on the plurality of metadata types and the plurality of content preferences. Here, the plurality of metadata types may be relevant to a data type corresponding to the plurality of viewed contents.

The processor 130 may obtain a metadata preference for a specific content using the above-described content preference. Specifically, the processor 130 may perform an initial setting. Here, the initial setting may mean setting the metadata preference to ‘0’.

The processor 130 may identify the content preference and each metadata type for each of the plurality of viewed contents. At this time, the processor 130 may add the content preference as a preference for each of the metadata types with respect to each of the metadata types for a specific viewed content.

If the user views new content and a viewing record (viewing time, number of viewings, likes, etc.) is added, the processor 130 may perform the initial setting for the new content. Then, the processor 130 may calculate the metadata preference for the new viewing content according to the content preference calculated from the viewing record.

If the user views new content and a new metadata type is added, the processor 130 may also perform the initial setting for the new metadata type. Then, the processor 130 may calculate the metadata preference for the new metadata type according to the relevant content preference.

For example, the specific viewing content (content A) may include metadata of ‘production year: 2022, Director: Kim so-and-so, genre: action’. In addition, the preference of the viewed content may be calculated as ‘X’.

In this case, the processor 130 may obtain the metadata preference such as ‘2022 produced content: X, Kim so-and-so director's work: X, action genre: X’ for a specific ‘viewing content A’.

If the user viewed a new content (content B), the processor 130 may reflect a content preference (preference calculated from a viewing record of content B) for content B.

Specifically, the content preference may be calculated as ‘Y’ from a new viewing record of new content B. If information of ‘production year: 2021, director: Kim so-and-so, genre: action’ is included in the metadata of the new content B, the processor 130 may obtain the metadata preference such as ‘2021 produced content: Y(=0+Y), 2022 produced content: X, Kim so-and-so director's work: X+Y, action genre: X+Y’.

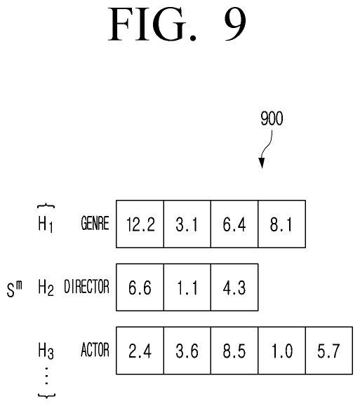

As described above, the processor 130 may obtain the metadata preferences. The processor 130 may obtain the preference list including the plurality of keywords sorted in an order of the plurality of metadata preferences. Here, a detailed description of the preference list will be described in detail below in FIG. 9.

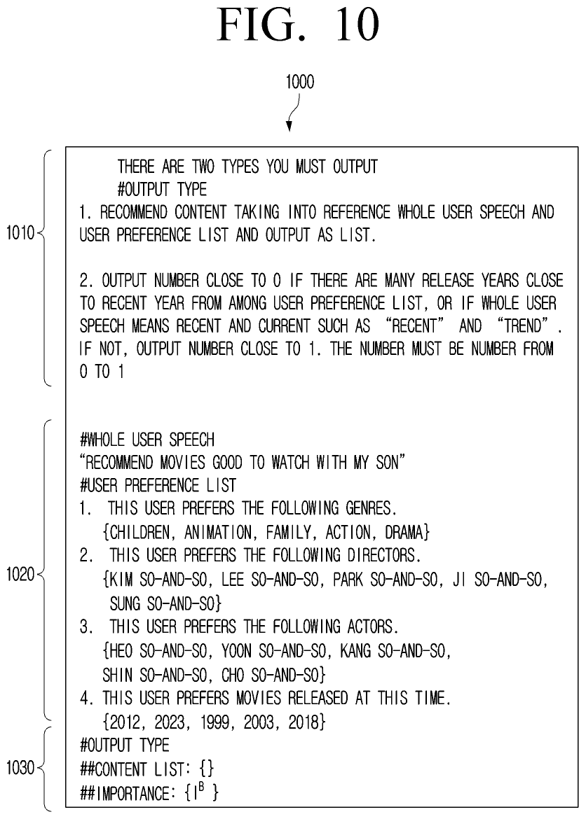

The processor 130 may obtain a prompt including a preference list for each of the plurality of metadata types. Here, the prompt including the preference list will be described in greater detail through FIG. 10.

According to an embodiment, the processor 130 may obtain the recommended content information through the at least one artificial intelligence model based on data including the prompt. Here, the data may be relevant to the above-described input data.

For example, the at least one artificial intelligence model may output metadata corresponding to the prompt. Here, the metadata corresponding to the prompt may be relevant to metadata for content requested in the prompt.

For example, the prompt may include a preference list together with a user speech of ‘recommend movies good to watch with a child’. At this time, the preference list may include information that the preferred genre of the user is ‘action, blockbuster, SF’. At this time, the at least one artificial intelligence model may output metadata (e.g., title, running time, production year, work code, etc.) for ‘action suitable for viewers of 7 years or younger, blockbuster contents’.

According to an embodiment, the recommended content information based on the user input and use history information may be internally recommended content information through the at least one artificial intelligence model based on data obtained based on the user input and the use history information.

The recommended content information based on the user input and use history information may be internally recommended content through the at least one artificial intelligence model. The at least one artificial intelligence model may correspond to at least one model based on data obtained based on the user input and the use history information.

For example, the processor 130 may obtain the internally recommended content information through the at least one artificial intelligence model based on data. Specifically, the processor 130 may obtain the internally recommended content information by inputting data in the at least one artificial intelligence model.

Here, the data may be relevant to the above-described input data. Here, the input data may be relevant to data obtained based on the user input and the use history information. Because the input data has been described above, redundant descriptions thereof will be omitted.

Here, each of the internally recommended content information and the recommended content information obtained external to the electronic apparatus, may include a plurality of candidate contents. Here, the plurality of candidate contents included in the internally recommended content information may mean content output as the recommended content by the at least one artificial intelligence model (e.g., internal LLM).

Here, the plurality of candidate contents included in the externally recommended content information may mean content output as the recommended content by the external LLM. However, the embodiment is not limited thereto.

Here, the processor 130 may obtain a plurality of scores for each of the plurality of candidate recommended contents included in each of the internally recommended content information and the externally recommended content information based on the use history information.

Here, a score may be relevant to a score for identifying content which is to be finally recommended to the user from among the plurality of candidate contents.

Specifically, the processor 130 may obtain content importance through the at least one artificial intelligence model. For example, the processor 130 may input a prompt including text for requesting the content importance in the at least one artificial intelligence model.

The content importance may be a criterion for determining whether the specific content is a relatively new content and if it is a trending content. Here, the content importance may have a value between 0 and 1.

For example, the text for requesting the content importance may be relevant to ‘output a number close to 0 if there are many release years close to the recent year from among the user preference list, or if the whole of the user speech means recent and current such as “recent” and “trend”. If not, output a number close to 1. The numbers must be a number from 0 to 1’.

In this case, the closer the specific content importance is to 0, the higher likelihood may be for the content to be a recent content (recently produced movie, drama, music video, etc.) or currently trending content.

However, the embodiment is not limited thereto, and the prompt may include a request to output a number close to 0 for content with a “high rating”.

An operation of the processor 130 obtaining the recommended content information (final recommended content information) using the content importance described above, the internally recommended content information, and the like will be described in detail below.

The processor 130 may obtain an external LLM search result, an internal LLM search result, a number of times the user selected the result recommended from the external LLM after recommendation, a number of times the result recommended from the internal LLM is selected n^{b}, and I^{B} output from a first algorithm, and the like.

Here, C^{a} and C^{b} may include an arrangement of IDs of each of the plurality of candidate contents. Here, the ID may be relevant to a type of identification information (metadata) for identifying a candidate content.

For example, the ID may be relevant to a unique number or string with which each content can be uniquely identified when a content is reproduced or stored in the electronic apparatus 100 or the external electronic apparatus.

Here, I^{B} may mean the content importance. Here, the search result may mean a list of contents (and metadata) recommended by the external LLM or the internal LLM.

First, the processor 130 may generate an arrangement of l^{a} and l^{b} and perform initialization to 0. Here, l^{a} arrangement may mean a content preference arrangement of the external LLM search result. Here, l^{b} may mean a content preference arrangement of the internal LLM search result.

Here, because the content preference has been described above, redundant descriptions thereof will be

[symbol]

If value is less than or equal to, the processor 130 may multiply I^{B} to l^{b}. Here, T^{I,lower} may be relevant to a first importance threshold value. T^{I,lower} may be set to various values according to a user setting, or the like. Then, the processor 130 may sort in descending order by l^{a} and l^{b} scores after merging C^{a} and C^{b}.

Even if I^{B} value exceeds T^{I,lower}, when the value is less than or equal to T^{I,upper}, the processor 130 may multiply I^{B} to l^{b}. Here, Y^{I,upper} may be relevant to a second importance threshold value. The second importance threshold value may be relevant to an importance threshold value greater than the first importance threshold value.

l^{b} may be relevant to the content preference arrangement recommended in the internal LLM as described above. Here, because l^{b} is a result recommended by already reflecting a user viewing history, there may be a tendency to have a higher score than l^{a}. To correct the above, the processor 130 may multiply I^{B} even when it is lower than T^{I,upper}.

Meanwhile, if I^{B} is higher than T^{I,upper}, the processor 130 may perform the following operation without multiplying I^{B} to l^{b}.

If I^{B} value exceeds T^{I,lower} as described above, the processor 130 may reflect a relative ratio of n^{a} and n^{b} to l^{a}, l^{b}. The processor 130 may multiply n^{a}/(n^{a}+n^{b}) to l^{a}, and multiply n^{b}/(n^{b}+n^{b}) to l^{b}.

Here, n^{a} may mean the number of times the user selected the result recommended from the external LLM after recommendation. n^{b} may mean the number of times the user selected the result recommended from the internal LLM. n^{a} and n^{b} may indicate which content recommended from which LLM the user preferred.

Here, the selecting the result may mean the user selecting the content to be viewed from among the recommended contents after the recommended contents are shown to the user.

That is, if I^{B} value exceeds T^{I,lower}, I^{B} may be multiplied to l^{B} like when I^{B} value is less than or equal to T^{I,lower}, but the processor 130 may reflect an influence for the LLM preferred by the user (i.e., LLM which outputs the recommended result mainly selected by the user).

Through the above, the processor 130 may reflect a tendency in user selection such as which content recommended result of the external LLM the user mainly views, or which content recommended result of the internal LLM the user mainly views in the final preference (score).

Meanwhile, the internal LLM may recommend, unlike the external LLM, content based on content information (viewing record, use history information, etc.) viewed by the user. Conversely, the recommended content result of the external LLM may have a tendency of recommending trending content.

When the processor 130 obtains the final recommended content information taking into reference only the content preference calculated previously, the final recommended content information may already be concentrated on the recommended content result of the internal LLM.

To solve the above, the processor 130 may obtain content importance I^{B} through the internal LLM, and calculate the final preference (or score) using I^{B}. That is, if the content recommended by the internal LLM is recent (or trending), the processor 130 may multiply I^{B} to the content preference to prevent the problem of the recommended contents being concentrated on new content.

Then, the processor 130 may merge C^{a} and C^{b} and then, sort in descending order by l^{a} and l^{b} scores gained therefrom and end the same.

For example, the processor 130 may match the scores included in l^{a} and l^{b} by each of a plurality of candidate content IDs included in each of content C^{a} and content C^{b}, and list the plurality of candidate contents or order of the scores.

In this case, the processor 130 may sort the plurality of candidate contents in descending order according to a size of the score.

According to an embodiment, the provided recommended content information may include identification information for a plurality of recommended contents. The plurality of recommended contents may correspond to a plurality of contents identified from among the plurality of candidate recommended contents based on the plurality of scores.

For example, the processor 130 may identify a plurality of recommended contents from among the plurality of candidate contents, based on the plurality of obtained scores. Here, the plurality of identified contents of the plurality of contents may be relevant to contents which are to be provided to the user by the electronic apparatus 100.

For example, the processor 130 may then control the display to display contents of a determined number (or thumbnail images, titles, etc.) from the content list. The above will be described in detail in the following description.

Here, the processor 130 may obtain the recommended content information including identification information for each of the plurality of identified recommended contents.

For example, the recommended content information may include a list of recommended contents for providing to the user. Here, the list may include a thumbnail image, a title, and the like for each of the identified recommended contents.

According to an embodiment, the provided recommended content information may include a plurality of playable contents from among the recommended content information obtained external to the electronic apparatus.

For example, the processor 130 may obtain the recommended content information including a plurality of playable contents from among the externally recommended content information. Here, the playable contents may mean contents that are playable in the electronic apparatus 100. The externally recommended content information may the recommended content information obtained external to the electronic apparatus.

Here, a playable content may mean a content which is already stored in the electronic apparatus 100, or which can be reproduced by receiving the same from a content source via streaming or download.

According to an embodiment, the processor 130 may obtain the recommended content information through the at least one artificial intelligence model based on the externally recommended content information and data. Here, the externally recommended content information may be relevant to content information received from the external electronic apparatus and the like through the communication part 120.

Here, the at least one artificial intelligence model may include the model trained to output the recommended content information based on the use history information and the externally recommended content information.

Here, the at least one artificial intelligence model may be trained to output playable content in the electronic apparatus 100 from among the recommended contents by the external LLM. Alternatively, the at least one artificial intelligence model may be trained to output contents (metadata of contents) excluding the new content (or trending content) from among the recommended contents by the external LLM. However, the embodiment is not limited thereto.

For example, the at least one artificial intelligence model may receive not only the viewing record, but also input of the result output by the external LLM and accordingly, output the recommended content information.

Here, the data may be relevant to data obtained based on the user input and the use history information. The data may include the prompt. Because the above has been described in detail above, redundant descriptions thereof will be omitted.

The processor 130 may use an artificial intelligence model trained based on the result output by the external LLM as described.

Accordingly, the processor 130 may not merge the internal LLM result and the external LLM result after obtaining both (in parallel), and obtain the recommended content information by utilizing the external LLM result directly as input information of the internal LLM.

As described above, the processor 130 may obtain the recommended content information using both an external LLM recommended result and an internal LLM recommended result.

Accordingly, the processor 130 may recommend contents more suitable to user preference (inclination) without being concentrated toward specific contents (new contents and trending contents reflecting viewing characteristics of a plurality of users or contents with high ratings, etc.) compared to when using only the external LLM.

In FIG. 2, although the electronic apparatus 100 has been shown as including only basic configurations, the electronic apparatus 100 may further include various configurations in addition to the above-described configurations.

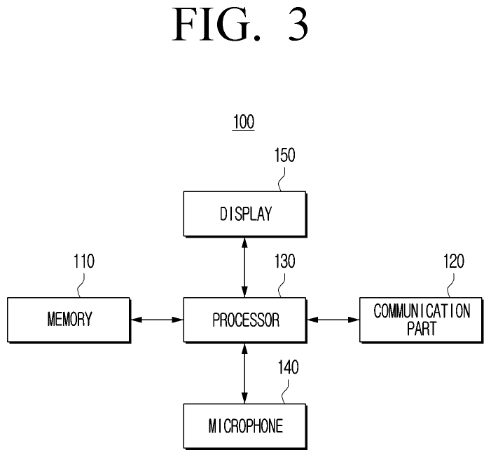

FIG. 3 is a detailed block diagram illustrating a detailed configuration of an electronic apparatus according to one or more embodiments of the disclosure.

Referring to FIG. 3, the electronic apparatus 100 may include the memory 110, the communication part 120, the processor 130, a microphone 140, and a display 150. Here, because the memory 110, the communication part 120, and the processor 130 have already been described, the embodiment above will be described with the redundant descriptions thereof omitted.

Meanwhile, the electronic apparatus 100 may include the microphone 140. The microphone 140 may receive a voice of a user in an activated state. For example, the microphone 140 may be formed as an integrated-type integrated to an upper side or a front surface direction, a side surface direction or the like of the electronic apparatus 100.

The microphone 140 may include various configurations such as a sensor that collects sound in an analog form, an amplifier circuit that amplifies the collected user voice, an A/D converter circuit that samples the amplified user voice and converts to a digital signal, a filter circuit that removes noise components from the converted digital signal, and the like.

The microphone 140 may transmit the received user voice to the electronic apparatus 100. Then, the electronic apparatus 100 may perform voice recognition by inputting the received user voice in a voice recognition model. For example, the electronic apparatus 100 may perform Speech to Text (STT) to the user voice, and perform voice recognition on the user voice.

Here, the user voice may be relevant to a voice by the user speech. For example, the user speech may be relevant to a speech of the user for requesting the recommended content. Here, because the speech of the user has been described above, redundant descriptions thereof will be omitted.

The electronic apparatus 100 may include the display 150.

The display may be a configuration for displaying an operation state or notification message of the electronic apparatus 100, a UI screen, and the like. The display may be implemented as a display of various forms such as a Liquid Crystal Display (LCD), an Organic Light Emitting Diode (OLED) display, a Plasma Display Panel (PDP), and the like. In the display, a driving circuit, which may be implemented in a form of an amorphous silicon thin film transistor (a-si TFT), a low temperature poly silicon (LTPS) TFT, an organic TFT (OTFT), or the like, a backlight unit, and the like may be included. Meanwhile, the display may be implemented as a touch screen coupled with a touch sensor, a flexible display, a three-dimensional display (3D display), or the like. Alternatively, the display may be implemented with one or a plurality of light emitting devices.

For example, the processor 130 may control the display 150 to display the recommended content information. Here, the processor 130 may display metadata such as titles, thumbnails, production years, and the like of the recommended content as a list. Here, the list may include metadata of a portion from among the above-described plurality of candidate recommended contents.

The processor 130 may control, based on receiving a user operation input for selecting one from among the displayed recommended contents, the display 150 to display the selected content.

For example, the processor 130 may control the display 150 to display a reproduction screen or a thumbnail image of a selected content in full screen. However, the embodiment is not limited thereto.

The electronic apparatus 100 may have the user intuitively identify a state of the electronic apparatus 100 by changing a display state of the display according to various states such as when the electronic apparatus 100 is in a turned-on state, when in a normally operating state, or when in a power shortage or in an error state.

However, the configuration of the display is merely a portion from among the various embodiments, and the display configuration may be omitted. That is, the electronic apparatus 100 may be an apparatus which directly includes the display, or an apparatus connected with an external apparatus.

For example, if the electronic apparatus 100 is implemented as a set top box, a one-connect box, a projector, or the like, the operations of the above-described electronic apparatus 100 may be performed in an electronic apparatus that does not include the display.

Meanwhile, in FIG. 3, although the electronic apparatus 100 included with various additional configurations has been shown, a portion of the configurations from among the configurations shown may be implemented in an omitted form. In addition, although not shown, other configurations may be further included.

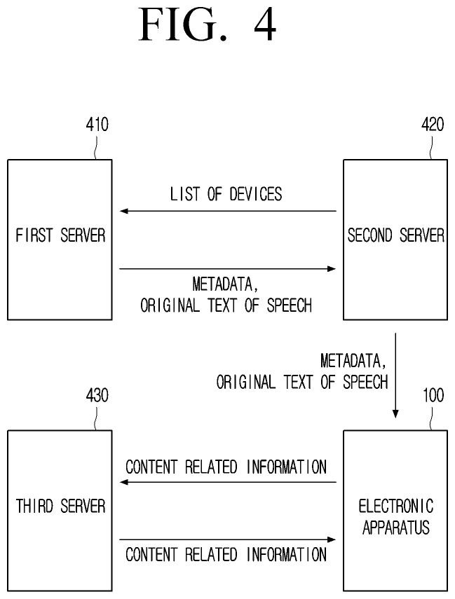

FIG. 4 is a diagram illustrating an operation of an electronic apparatus according to one or more embodiments of the disclosure.

Referring to FIG. 4, a first server 410, a second server 420, a third server 430, and the electronic apparatus 100 are shown.

The second server 420 may provide a list of devices to the first server 410. Here, the list of devices may be relevant to a list of electronic devices (e.g., TV, smartphone, tablet, set top box, etc.) communicable with the second server 420.

The first server 410 may provide metadata and an original text of speech to the second server 420 based on the provided list of devices. For example, the first server 410 may provide the metadata and the original text of speech for providing to a device (e.g., electronic apparatus 100) included in the provided list of devices to the second server 420.

Here, the metadata may be relevant to metadata of content recommended by the external LLM. Here, the external LLM may be relevant to the LLM stored in the first server 410.

Here, the original text of speech may be relevant to an original text of a speech voice of the user converted to text. Here, the user speech may be relevant to a speech for requesting content recommendations by the user. Here, the speech voice of the user may be input through at least one from among the first server 410 to the third 430 and the electronic apparatus 100.

The electronic apparatus 100 may receive the metadata and the original text of speech from the second server 420. The electronic apparatus 100 may provide, based on the received metadata, content related information to the third server 430. Here, the content related information may include a content list corresponding to the received metadata. However, the embodiment is not limited thereto.

The third server 430 may receive the content related information from the electronic apparatus 100. The third server 430 may identify playable content from the electronic apparatus 100 from among the received content related information.

The third server 430 may provide content related information corresponding thereto to the electronic apparatus 100. Here, the content related information provided by the third server 430 may be relevant to a list of playable contents in the electronic apparatus 100.

As described, the electronic apparatus 100 may receive the metadata and the original text of speech from the second server 420 which is directly communicable with the electronic apparatus 100, and receive directly from the first server 410.

An operation of the electronic apparatus 100 obtaining the recommended content information by communicating with at least one from among the first server 410 to the third server 430 will be described in detail below.

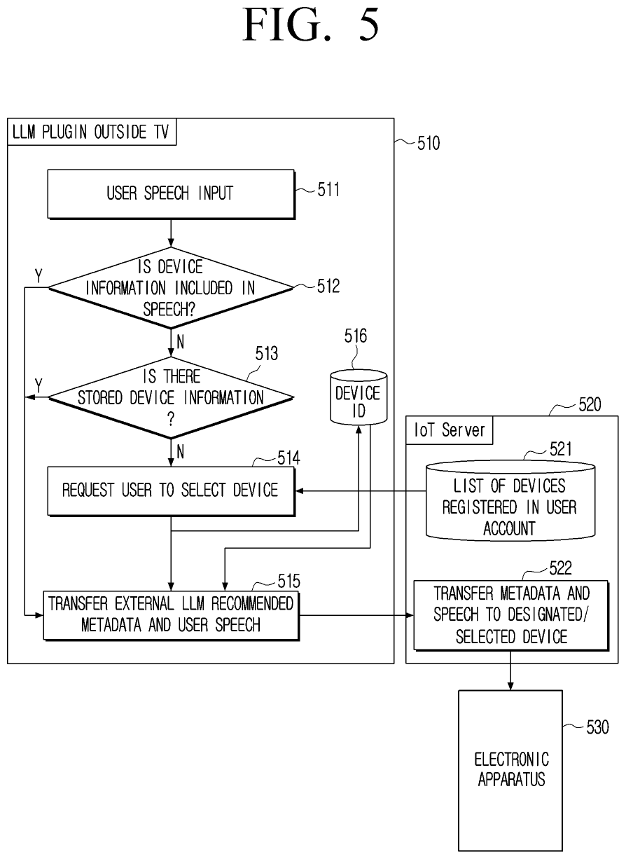

FIG. 5 is a diagram illustrating a first server and a second server according to one or more embodiments of the disclosure.

Referring to FIG. 5, a plug-in device 510, an IoT server 520, and a TV 530 are shown. Here, each of the plug-in device 510 and the IoT server 520 may be relevant to the first server and the second server described in FIG. 4.

Meanwhile, the electronic apparatus described in FIG. 4 may be implemented as the TV 530. In this case, the plug-in device 510 may be relevant to a device for using the LLM outside of the TV. Here, the plug-in device 510 may be connected with the IoT server 520 and provide an LLM server remotely.

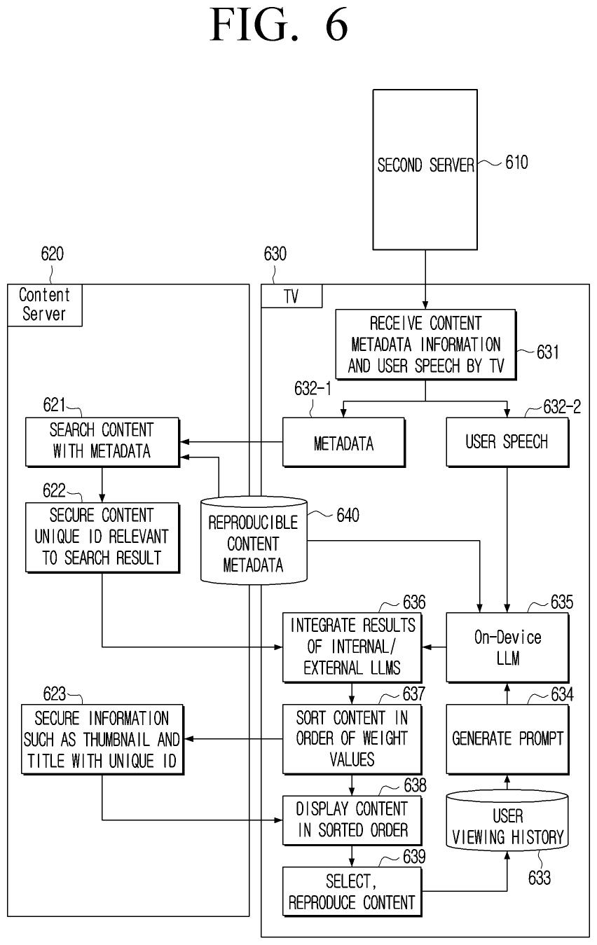

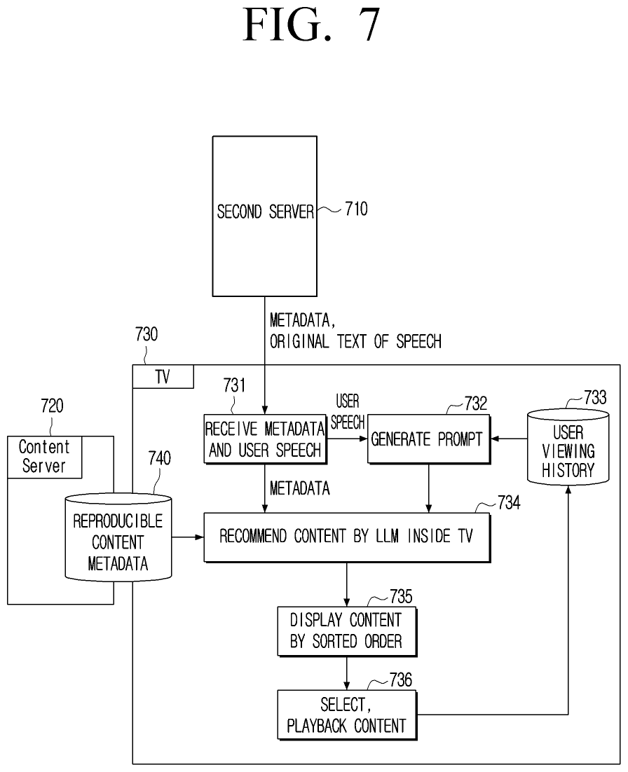

In FIG. 5, the electronic apparatus has been described using the TV 530 as an example, but is not necessarily limited thereto, and the electronic apparatus may be implemented as apparatuses of various types in addition thereto. The same applies in FIG. 6, FIG. 7, and the like below.

Here, the LLM outside the TV may be relevant to a type of the external LLM described above. Here, the external LLM may be relevant to a model which provides a conversation-type interface with the user. In addition, the external LLM may be relevant to a model capable of responding by searching the latest information through a web search in real-time.

For example, the original text of speech of the user (e.g., ‘recommend movies good to watch with a child’) may be input in the external LLM as the prompt. In this case, the external LLM may provide the recommended content information (e.g., recommended content list) corresponding to the relevant original text of speech as a response (recommended result).

The plug-in device 510 may receive input of the user speech (original text of speech of the user) (511), and identify whether device information is included in the speech. Here, the plug-in device 510 may identify whether the device information is included in a content of the speech through voice recognition (512). Here, the device information may mean the identification information of each of the devices communicable with the IoT server 520.

The plug-in device 510 may provide, based on the speech including the device information, the metadata and the original text of speech to the IoT server 520, in order for the recommended content (metadata) and the original text of speech to be transferred to the relevant device (515). Here, the metadata and the like may be relevant to metadata output (recommended) by the external LLM.

If the speech does not include the device information, the plug-in device 510 may identify whether there is device information stored in the plug-in device 510 (S513). The device information may mean a device ID. Here, the device ID may be stored in a device ID database 516 of the plug-in device 510.

If the device information is stored in the plug-in device 510, the plug-in device 510 may provide the metadata, the original text of speech, and the like to the IoT server 520 for the recommended content (metadata) and the original text of speech to be transferred to the relevant device (515).

If there was not even the device information stored in the plug-in device 510, a list of devices registered to a user account may be received from the IoT server 520. The plug-in device 510 may receive an input of a request for device selection from the user (514).

For example, the plug-in device 510 may receive a user operation input for selecting a device from the registered list of devices. Here, the registered list of devices may be stored in a device database 521 of the IoT server 520. Here, the device database 521 may store the list of devices registered to the user account.

At this time, when the user operation input is received, the plug-in device 510 may store the device selected by the user. The plug-in device 510 may store an ID of the device selected by the user at this time in the device ID database 516.

The plug-in device 510 may provide the metadata, the original text of speech, and the like to the IoT server 520 for the recommended content (metadata) and the original text of speech to be transferred to the relevant device (515).

The IoT server 520 may store and process data collected in various IoT devices (smartphone, TV, etc.), and may be relevant to an apparatus that manages communication between devices. The Internet of Things (IoT) may be relevant to a network system in which devices that are connected to one another through the Internet transmit and receive data interacting with one another.

The IoT server 520 may provide metadata and speech (voice or original text) to the TV 530 using a designated or selected device (522). Here, the designated or selected device may be relevant to a device corresponding to device information included in the user speech or device information stored in the device ID database 516.

The TV 530 may obtain the recommended content information using the metadata and speech received from the IoT server 520. The above will be described in detail below.

FIG. 6 is a diagram illustrating a third server and an operation of an electronic apparatus according to one or more embodiments or the disclosure.

Referring to FIG. 6, a second server 610, a content server 620, and a TV 630 are shown. Here, the second server 610 may be relevant to the IoT server described above in FIG. 5, and the content server 620 may be relevant to the third server described in FIG. 4.

The electronic apparatus described above in FIG. 4 may be implemented as the TV 630 as shown in FIG. 6. However, the electronic apparatus is not limited thereto.

The TV 630 may receive metadata 632-1 and a user speech 632-2 from the second server 610 (631).

Meanwhile, the TV 630 may generate a prompt 634 based on the user viewing history. Here, the user viewing history may be obtained from a viewing history database 633.

Here, the prompt 634 may be relevant to an instruction corresponding to the user input (user speech 632-2). Because the above has been described above, redundant descriptions thereof will be omitted.

The TV 630 may obtain the internally recommended content information by inputting the generated prompt in an on-device LLM (internal LLM) 635. Here, the internally recommended content information may be referred to as an internal LLM result.

Here, the TV 630 may use the metadata of the playable content as input data of the on-device LLM 635. Accordingly, the on-device LLM 635 may output the recommended content information that includes playable content.

Here, the metadata of the playable content may be obtained from a metadata database 640. Here, the metadata database 640 may be stored in the TV 630 or the content server 620.

Meanwhile, the TV 630 may provide the metadata 632-1 received from the second server 610 to the content server 620.

The content server 620 may be relevant to a server that stores metadata, ID, and the like of content, and provides content such that the content is streamable or downloadable from an external apparatus (e.g., electronic apparatuses such as the TV 630, the set top box, and the like).

The content server 620 may search for content through metadata (621). For example, the content server 620 may identify whether the metadata received from the TV 630 is stored in the metadata database 640.

The content server 620 may obtain a search result if metadata that matches with the metadata received from the TV 630 is present from among the metadata database 640.

For example, the content server 620 may receive a title of a specific content from the TV 630. In this case, the content server 620 may check whether metadata corresponding to the relevant title is stored in the metadata database 640.

The content server 620 may obtain, if the metadata corresponding to the relevant title is stored, the metadata corresponding to the relevant title (e.g., direction, production year, actor, ID, etc. in addition to the title) as the search result. For example, the search result may include a unique ID of the content, but is not necessarily limited thereto.

At this time, the search result may be relevant to metadata of the playable contents from the TV 630 from among the recommended contents obtained through the external LLM.

The TV 630 may integrate the results of the internal and external LLMs after receiving the search result described above (e.g., ID) from the content server 630 (636). For example, the TV 630 may obtain scores of candidate recommended contents from the recommended content information obtained from each of the internal LLM and the external LLM.

Here, because the candidate recommended contents, the scores, and the like have been described above, redundant descriptions thereof will be omitted.

The TV 630 may sort the contents by an order of weight values (637). Here, a weight value may be relevant to the above-described score. However, the embodiment is not limited thereto.

The TV 630 may sort scores of candidate contents according to a specific order (e.g., descending order). Here, the weight value may be relevant to a value indicating a degree to which a specific content is recommended (or importance).

The TV 630 may provide the sorted content list to the content server 620. The content server 620 may use the unique ID of contents included in the content list, and secure related information (623). Here, the related information may be relevant to information for displaying content (title, thumbnail, etc.) corresponding to the relevant unique ID.

The TV 630 may display content in a sorted order by receiving related information from the content server 620 (638). For example, the TV 630 may display thumbnail images or titles in the sorted order.

When titles, thumbnails, and the like of the contents are displayed in the TV 630, the TV 630 may receive a user operation input for selecting one (or more) from among the recommended contents. The TV 630 may identify that the content corresponding to the user operation input is selected, and reproduce the selected content (639). The TV 630 may display the reproduction screen, or the like of the selected content.

The TV 630 may store information on the selected content as described above in a user viewing history database 633. Here, the information on the content may include the metadata and viewing history of the selected content. Here, the viewing history may include activity records of various types such as, for example, and without limitation, the viewing time, likes, number of repeated reproductions, and the like.

Then, the TV 630 may repeat the above-described processes by generating a prompt corresponding to the user speech 632-2 thereafter based on the database 633 accumulated with viewing histories as described above.

As the user speech 632-2 is continuously input thereafter, the prompt may be updated, and the internal LLM may output recommended content information more suitable to the viewing characteristics of the user.

FIG. 7 is a diagram illustrating an operation of an electronic apparatus according to one or more embodiments of the disclosure.

Referring to FIG. 7, a second server 710, a content server 720, and a TV 730 are shown. Here, the second server may be relevant to the IoT server shown in FIG. 5. The electronic apparatus shown in FIG. 4 may be implemented as the TV 730.

The TV 730 may receive metadata and original text of speech from the second server 710 (731). Here, the metadata may be relevant to the externally recommended content information. Here, because the metadata and the original text of speech have been described in the above-described drawing, redundant descriptions thereof will be omitted.

The TV 730 may generate a prompt from the received user speech and user viewing history (732). Here, the user viewing history may be obtained from a viewing history database 733. Because the prompt and the viewing history database 733 has been described above, redundant descriptions thereof will be omitted.

The TV 730 may recommend content through the LLM based on the metadata, the prompt, and metadata of playable contents (734). Here, the TV 730 may output, for example, metadata of contents to be recommended through the LLM.

Here, the metadata of the playable contents may be obtained from a metadata database 740. Here, the metadata database 740 may be stored in the TV 730 or the content server 720. Because the above has been described in detail above, redundant descriptions thereof will be omitted.

Here, the LLM may be relevant to the internal LLM stored in the TV 730. Here, the internal LLM may be trained to output metadata of recommended contents based on the metadata, the prompt, and the metadata of the playable contents obtained from the external LLM.

Here, the metadata output by the LLM may be relevant to metadata of a plurality of recommended contents. Here, the plurality of recommended contents may be relevant to the playable contents in the TV 730. Because the playable contents in the TV 730 have been described above, redundant descriptions thereof will be omitted.

The TV 730 may display content in a sorted order (735). For example, the TV 730 may display thumbnail images or titles in a sorted order. Here, the sorted order may be relevant to a descending order according to scores (or weight values). Here, the score and the weight value may be values calculated for each of the recommended contents.

Here, the recommended contents may be relevant to recommended contents displayed to the user from among a plurality of candidate recommended contents. Because the scores (weight values) and the candidate recommended contents have been described above, redundant descriptions thereof will be omitted.

When the titles, thumbnails, and the like of the contents are displayed in the TV 730, the TV 730 may receive a user operation input for selecting one (or more) from among the recommended contents. The TV 730 may identify that the content corresponding to the user operation input is selected, and reproduce the selected content (736). The TV 730 may display the reproduction screen and the like of the selected content.

The TV 730 may store information on the selected content as described above in a user viewing history database 733. Here, the information on the content may include the metadata and the viewing history of the selected content. Here, the viewing history may include activity records of various types such as, for example, and without limitation, the viewing time, likes, the number of repeated reproductions, and the like.

Then, the TV 730 may repeat the above-described processes by generating a prompt corresponding to a user speech thereafter based on the database 733 accumulated with viewing histories as described above.

As described, the LLM inside the TV 730 may receive input of metadata output by the external LLM (i.e., metadata of recommended contents by the external LLM) and output the metadata of the recommended contents (final recommended content).

Accordingly, the TV 730 may not merge the internal LLM result and the external LLM result after obtaining both (in parallel), and obtain the metadata of the recommended contents utilizing the external LLM result directly as input information of the internal LLM.

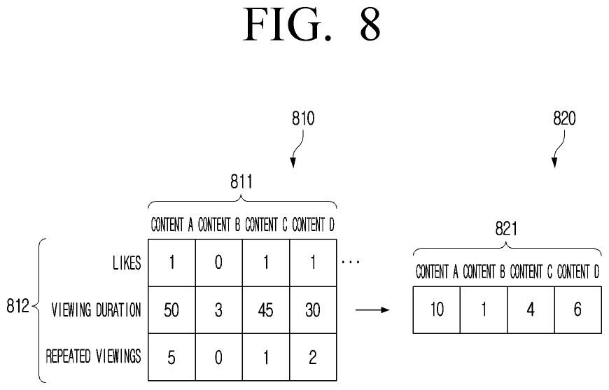

FIG. 8 is a diagram illustrating preference according to one or more embodiments of the disclosure.

Referring to FIG. 8, a first preference matrix 810 and a second preference matrix 820 are shown.

Here, the first preference matrix 810 may include preferences (total k×n number) for each of a plurality of items 812 (k number) for a plurality of viewed contents 811 (n number). The first preference matrix 810 may be relevant to a matrix with a size of k×n. Here, the plurality of viewed contents 811 may mean content recorded as having been reproduced through the electronic apparatus 100.

For example, the plurality of items 812 may include likes, viewing time, a number of repeated viewings, and the like. At this time, the preferences for each of the plurality of items 812 may be expressed as a number of likes, the viewing time (minutes), and the number of repeated viewings for each of the viewed contents.

Here, the preferences for each of the plurality of items 812 may be obtained from the use history information stored in the electronic apparatus 100. Here, the use history information may be stored in a server apparatus in a form of a database in addition to the electronic apparatus 100.

In this case, the electronic apparatus 100 may obtain the preferences for each of the plurality of items 812 by receiving the use history information from the database.

Meanwhile, the second preference matrix 820 may include final preferences (n number) for each of a plurality of viewed contents 821 (n number). The second preference matrix 820 may be relevant to a matrix with a size of 1×n. Here, the final preference may mean preferences for each of the above-described content.

The final preference may be obtained from the first preference matrix 810. Specifically, the electronic apparatus 100 may use a weight value matrix corresponding to the plurality of items 812 included in the first preference matrix 810.

Here, the weight value matrix may include a plurality of weight values corresponding to each of the plurality of items 812. If a number of the plurality of items 812 is k, a plurality of weight value matrices C may be relevant to a matrix with a size of 1×k.

Here, the plurality of weight values may mean weight values necessary for obtaining the final preference. That is, if the plurality of items 812 is relevant to likes, viewing time, repeated viewings, and the like, because units of each items vary, the electronic apparatus 100 may use the weight value described above to calculate the final preference.

If the first preference matrix 810 is P (n×k size), the second preference matrix 820 (1×n size) may be expressed as. That is, the second preference matrix 820 may be obtained by performing a dot product of the weight value matrix and the first preference matrix 810.

The electronic apparatus 100 may identify the final preference for each of a plurality of viewed contents 821 through the second preference matrix 820. The electronic apparatus 100 may obtain preferences associated with metadata using the above-described final preference. The above will be described in detail below in FIG. 9.

FIG. 9 is a diagram illustrating a hash map according to one or more embodiments of the disclosure.

Referring to FIG. 9, hash map sets 900 may be shown.

Here, the hash map sets 900 S^{m} may include a plurality of hash maps H_{1. . . m} designated for each of the plurality of metadata types. Here, the plurality of hash maps may include the preferences for each of a plurality of metadata items. Here, each of 1, . . . m may mean metadata types. For example, hash map H_{1 . . .m} may be relevant to Hgenre, Hdirector, Hactor,, and the like.

Here, each hash map may include the plurality of metadata items. Here, the plurality of metadata items may be listed in a pre-set order (e.g., order of preference, etc.)

Here, a metadata item may mean elements indicating individual values or attributes belonging to a specific metadata type (e.g., genre). For example, if the metadata type is genre, the metadata item may be relevant to action, melodrama, SF, and the like.

Meanwhile, the electronic apparatus 100 may obtain the preferences for each of the metadata items using the second preference matrix described in FIG. 8.

The electronic apparatus 100 may obtain the preferences for each of the metadata items using the metadata of the viewed content and the final preference. For example, with respect to each of the metadata items (e.g., ‘director: Kim so-and-so, genre: action, actor: Park so-and-so’, etc.) of the viewed content, the final preference of the relevant viewed content may be set as the preferences for each of the relevant items.

If the user newly viewed a content (if n is increased), there may be items that were not initialized in the hash map (e.g., director, genre, and the like which were not included in the existing hash map). In this case, the electronic apparatus 100 may add a new metadata item to each hash map H_{1 . . . m} and initialize the relevant item to 0.

Then, the electronic apparatus 100 may update the hash map sets 900. The electronic apparatus 100 may add, based on a j-th metadata item of an i-th viewing content and a metadata item located at Hⱼ from among the plurality of hash maps being a match, an existing preference of an item with the final preference of the i-th viewing content.

Here, the i-th may mean the i-th from the left in the second preference matrix. Here, the j-th may mean the j-th from the left in the hash map.

The electronic apparatus 100 may sort a preference size of each item in descending order for every H_{1 . . . m} of S^{m} updated as described above. The electronic apparatus 100 may generate a list L_{1 . . . m} by selecting from a first item to a specific item. Here, the list L_{1 . . . m} may mean a list of selected items by a pre-set number to generate a prompt.

Then, the electronic apparatus 100 may generate a prompt which reflects the list L_{1. . . m}. The above will be described in detail in FIG. 10.

FIG. 10 is a diagram illustrating a prompt according to one or more embodiments of the disclosure.

Referring to FIG. 10, a prompt 1000 is shown.

Here, the prompt 1000 may include command texts divided into a plurality of sections. Here, the plurality of sections may be relevant to a first section 1010, a second section 1020, and a third section 1030.

The first section 1010 and the third section 1030 may each include a command text for an output type. The first section 1010 may include information on the output type and a required response (LLM output result). For example, the first section 1010 may include information requesting a ‘list of recommended contents’ and content importance (0-1)′.

Here, the content importance may mean the above-described value. The value may be used to integrate the external LLM output result and the internal LLM output result. Because the above has been described above, redundant descriptions thereof will be omitted.

The third section 1030 may indicate specific information on the output type. For example, the third section 1030 may include information requesting for the recommended content list to be responded in a form such as {recommended content A, recommended content B, . . .}. In addition, the second section 1020 may include information requesting for the content importance to be responded in a form such as {I^{B}}.

Meanwhile, the second section 1020 may include a whole user speech (original text) and the user preference list.

Here, the preference list may be obtained from the list L_{1 . . . m}. Here, the list L_{1 . . . m} may be relevant to a list generated with items of high preference that are selected from among the metadata items as described in FIG. 9.

Here, because a more detailed description of the preference list has been described in detail in FIG. 2, redundant descriptions thereof will be omitted.

That is, the second section 1020 may include not only the content of the whole user speech, but also the user preference list in order for the internal LLM to output a result suitable to the user. The internal LLM may be trained to recommend content based on the user preference list (or output metadata on the recommended content).

Accordingly, the electronic apparatus 100 may input the prompt 1000 including the first section 1010 to the third section 1030 in the internal LLM. The electronic apparatus 100 may obtain the recommended content information from the content of the response (recommended content list, importance, etc.) to the relevant prompt 1000.

Through the above, the electronic apparatus 100 may use the recommended content list (internally recommended content information), the importance, and the external LLM result (externally recommended content information), and obtain the final recommended content information.

That is, despite the electronic apparatus 100 using both the internal LLM and the external LLM, because the content importance obtained through the internal LLM is used, the final recommended contents may not be concentrated toward one side of the LLM result.

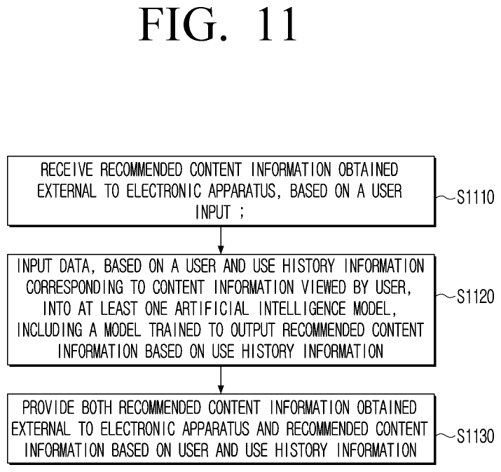

FIG. 11 is a flowchart illustrating a controlling method of an electronic apparatus according to one or more embodiments of the disclosure.

The electronic apparatus 100 may receive recommended content information obtained external to the electronic apparatus, based on a user input(1110).

For example, the electronic apparatus 100 may receive the externally recommended content information based on a user input corresponding to a request for the recommended content information.

Then, the electronic apparatus 100 may input data, based on the user input and use history information corresponding to content information viewed by the user, into at least one artificial intelligence model, including a model trained to output recommended content information based on use history information(S1120).

Then, the electronic apparatus 100 may provide both the recommended content information obtained external to the electronic apparatus and the recommended content information based on the user input and use history information(S1130).

The recommended content information obtained external to the electronic apparatus may be the externally recommended content information.

For example, the electronic apparatus 100 may obtain, through the at least one artificial intelligence model, the recommended content information based on data obtained based on the user input and the use history information.

Here, the recommended content information may include a portion from among the externally recommended content information. Here, the at least one artificial intelligence model may include the model trained to output the recommended content information based on the use history information.

Accordingly, the electronic apparatus 100 may obtain the recommended content information using both the external LLM recommended result and the internal LLM recommended result.

Accordingly, the processor 130 may recommend contents more suitable to the user preference without being concentrated toward a specific content (new content, trending content, or contents with high rating, etc. reflected with viewing characteristics of a plurality of users) compared to when using only the external LLM.

Meanwhile, in FIG. 11, although the order of all steps has been mapped for convenience of description, it should be noted that the order of steps, which have no relevance to order or which can be performed in parallel, is not necessarily limited to the relevant order.

Meanwhile, methods according to at least a portion from among the various embodiments of the disclosure described above may be implemented in an application form installable in an electronic apparatus of the related art.

In addition, methods according to at least a portion from among the various embodiments of the disclosure described above may be implemented with only a software upgrade or a hardware upgrade of the electronic apparatus of the related art.

In addition, methods according to at least a portion of the various embodiments of the disclosure described above may be performed through an embedded server provided in the electronic apparatus, or through at least one external server from among the electronic apparatuses.

Meanwhile, according to an embodiment of the disclosure, the various embodiments described above may be implemented with software including instructions stored in a machine-readable storage media (e.g., computer). The machine may call a stored instruction from a storage medium, and as an apparatus operable according to the called instruction, may include an electronic apparatus (e.g., electronic apparatus (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium. For example, the ‘non-transitory storage medium’ may include a buffer in which data is temporarily stored. According to an embodiment, a method according to the various embodiments described in the disclosure may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

The various embodiments of the disclosure may be implemented with software including instructions stored in the machine-readable storage media (e.g., computer). The machine may call the stored instruction from the storage medium, and as an apparatus operable according to the called instruction, may include the electronic apparatus (e.g., electronic apparatus 100) according to the above-mentioned embodiments.

When the above-described command is executed by the processor, the processor may directly or using other elements under the control of the processor perform a function relevant to the command. The command may include a code generated by a compiler or executed by an interpreter.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a memory configured to store at least one instruction and at least one artificial intelligence model;
a communication part; and
at least one processor configured to, by executing the at least one instruction, cause the electronic apparatus to:
receive, through the communication part, recommended content information obtained external to the electronic apparatus, based on a user input,
input data, based on the user input and use history information corresponding to content information viewed by the user, into the at least one artificial intelligence model, including a model trained to output recommended content information based on use history information, and
provide both the recommended content information obtained external to the electronic apparatus and the recommended content information based on the user input and use history information.

2. The electronic apparatus of claim 1, wherein
the at least one processor is configured to:
obtain a prompt associated with a request for identification information for at least one content corresponding to the user input based on the use history information, and
obtain the recommended content information through the at least one artificial intelligence model based on data including the prompt.

3. The electronic apparatus of claim 2, wherein the at least one processor is configured to:
obtain the prompt including a preference list for a plurality of metadata types based on metadata included in the use history information.

4. The electronic apparatus of claim 3, wherein the at least one processor is configured to:
obtain the preference list including a plurality of keywords sorted in an order of preference for the plurality of metadata types, and
obtain the prompt including the preference list.

5. The electronic apparatus of claim 4, wherein the at least one processor is configured to:
obtain a plurality of content preferences for a plurality of viewing contents from an activity record on the plurality of viewing contents included in the use history information,
obtain a plurality of metadata preferences divided by the plurality of metadata types based on the plurality of metadata types corresponding to the plurality of viewing contents and the plurality of content preferences, and
obtain the preference list including the plurality of keywords sorted in an order of the plurality of metadata preferences.

6. The electronic apparatus of claim 5, wherein the activity record includes a plurality of values divided by a plurality of activity types, and the at least one processor is configured to:
obtain a plurality of weighted sums calculated for the plurality of viewing contents as the plurality of content preferences based on a plurality of weight values corresponding to the plurality of values and the plurality of activity types respectively.

7. The electronic apparatus of claim 1, wherein the recommended content information based on the user input and use history information is internally recommended content information through the at least one artificial intelligence model based on data obtained based on the user input and the use history information,
the at least one processor is configured to:
obtain a plurality of scores for a plurality of candidate recommended contents included in the internally recommended content information and the recommended content information obtained external to the electronic apparatus, respectively, based on the use history information, and
the provided recommended content information including identification information for a plurality of identified recommended contents from among the plurality of candidate recommended contents based on the plurality of scores.

8. The electronic apparatus of claim 1, wherein the at least one processor is configured to:
the provided recommended content information including a plurality of playable contents from among the recommended content information obtained external to the electronic apparatus.

9. The electronic apparatus of claim 1, wherein the at least one artificial intelligence model includes a model trained to output recommended content information based on both the use history information and the recommended content information obtained external to the electronic apparatus, and the at least one processor is configured to:
obtain the recommended content information through the at least one artificial intelligence model based on the recommended content information obtained external to the electronic apparatus and the data.

10. The electronic apparatus of claim 1, wherein the user input includes text obtained from a user voice input corresponding to a request for the recommended content information.

11. A method for controlling an electronic apparatus, the method comprising:
receiving recommended content information obtained external to the electronic apparatus, based on a user input ;
inputting data, based on the user input and use history information corresponding to content information viewed by the user, into at least one artificial intelligence model, including a model trained to output recommended content information based on use history information, and
providing both the recommended content information obtained external to the electronic apparatus and the recommended content information based on the user input and use history information.

12. The method of claim 11, wherein the method further comprises:
obtaining, based on the use history information, a prompt associated with a request for identification information for at least one content corresponding to the user input; and
obtaining the recommended content information through the at least one artificial intelligence model based on the data including the prompt.

13. The method of claim 12, wherein the method further comprises:
providing the prompt including a preference list for a plurality of metadata types based on metadata included in the use history information.

14. The method of claim 13, wherein the method further comprises:
providing the preference list including a plurality of keywords sorted in an order of preference for the plurality of metadata types; and
obtaining the prompt including the preference list.

15. A non-transitory computer-readable recording medium storing computer instructions for an electronic apparatus to perform an operation based on execution by a processor of the electronic apparatus, the operation comprising:
receiving recommended content information obtained external to the electronic apparatus based on a user input;
inputting data, based on the user input and use history information corresponding to content information viewed by the user, into at least one artificial intelligence model, including a model trained to output recommended content information based on use history information; and
providing both the recommended content information obtained external to the electronic apparatus and the recommended content information based on the user input and use history information.
